(19) United States
(12) Patent Application Publication
(10) Pub. No.: US 2026/0024709 A1
(43) Pub. Date: Jan. 22, 2026

(54) DEVICE FOR ELIMINATING BOUNCING OF ELECTRICAL CONTACTS IN ELECTRICAL WIRING DEVICES

(71) Applicant: EATON INTELLIGENT POWER LIMITED, DUBLIN 4 (IE)

(72) Inventors: JASON ROY OLIVER, Peachtree City, GA (US); CHUANCHUAN ZHUANG, Shanghai (CN); FENGGUO ZHANG, Shanghai (CN); ROBIN LU GUIQUAN, Dongguan (CN)

(73) Assignee: EATON INTELLIGENT POWER LIMITED, DUBLIN 4 (IE)

(21) Appl. No.: 18/779,541

(22) Filed: Jul. 22, 2024

(51) Int. Cl. H01H 1/50; H01H 3/54

(52) U.S. Cl. CPC H01H 1/50; H01H 3/54; H01H 2201/002

(57) ABSTRACT

An electrical wiring device includes a traveler conductor with a bracing portion that couples the traveler conductor to a support structure formed in the housing of the device. The bracing portion and the support structure facilitate an interference fit between the bracing portion and the support structure. A flipper conductor of the wiring device is structured to be actuated between a first position and a second position, in order to supply power and cut off power to a load electrically connected to the wiring device. When the flipper conductor moves from the second position to the first position, there is an impact on the traveler conductor. The bracing portion has angled cuts that enable the bracing portion to tilt slightly back and forth upon impact from the flipper conductor. The angled cuts and the thermoplastic material properties of the support structure significantly reduce bouncing of the overall traveler conductor structure.

### FIELD OF THE INVENTION

The disclosed concept relates generally to electrical wiring devices, and in particular, to systems for preventing unwanted micro-vibrations or bouncing of electrical contacts in electrical wiring devices.

### BACKGROUND OF THE INVENTION

Electrical wiring devices are widely used in residential, commercial, and industrial buildings. Common examples of such devices include electrical outlet receptacles and light switches. A light switch wiring device is structured to be electrically connected between a light fixture and the utility/mains power provided to a building, and includes a faceplate with an actuating mechanism that enables a user to toggle the switch between an OFF state and an ON state. The light switch also includes a stationary conductor comprising a contact (i.e. a stationary contact) and a movable conductor comprising a contact (i.e. a movable contact). The movable conductor is structured to be actuated by the toggle between an open position corresponding to the switch being in the OFF state and a closed position corresponding to the switch being in the ON state. When the movable conductor is in the open position, the movable contact is physically separated from stationary contact, such that the circuit connecting the light fixture to the building's power is open. In contrast, when the movable conductor is in the closed position, the movable contact is in physical contact with the stationary contact, such that the circuit connecting the light fixture to the building's power is closed.

When a user toggles the switch from the OFF state to the ON state, the impact of the movable contact on the stationary contact can cause micro vibrations (also referred to as bouncing) to occur in the stationary conductor. This causes the electrical connection between the stationary contact and the movable contact to be intermittent, which results in undesirable arcing. This arcing causes noticeable physical degradation of the stationary and movable contacts over time, thus also leading to noticeable performance degradation over time.

There is thus room for improvement in electrical wiring devices and in electrical conductors and contacts therefor.

### SUMMARY OF THE INVENTION

These needs, and others, are met by an improved electrical wiring device that includes a stationary traveler conductor with an advantageously structured bracing portion that enables the stationary traveler conductor to be coupled to a support structure formed in the housing of the device and significantly reduces bouncing of the stationary traveler conductor's majority portion.

In accordance with one aspect of the disclosed concept, a bracing portion for stabilizing a traveler conductor in an electrical wiring device comprises: a bent portion structured to be coupled to the traveler conductor, and a planar portion. The planar portion is adjacent to the bent portion and comprises an inlet. The inlet comprises: a first planar inlet surface; a second planar inlet surface; and a connecting inlet surface that extends between the first planar inlet surface and the second planar inlet surfaces. The first planar inlet surface and the second planar inlet surface face one another. The inlet is structured to receive a support structure of the electrical wiring device.

In accordance with another aspect of the disclosed concept, a traveler conductor for an electrical wiring device comprises: a majority portion, and a bracing portion structured to stabilize the traveler conductor. The bracing portion comprises a bent portion structured to be coupled to the majority portion, and a planar portion. The planar portion is adjacent to the bent portion and comprises an inlet. The inlet comprises: a first planar inlet surface; a second planar inlet surface; and a connecting inlet surface that extends between the first planar inlet surface and the second planar inlet surface. The first planar inlet surface and the second planar inlet surface face one another. The inlet is structured to receive a support structure of the electrical wiring device.

In accordance with another aspect of the disclosed concept, an electrical wiring device structured to switch power between a power source and a load includes: a first traveler conductor comprising a first traveler contact; a line conductor; a second traveler conductor comprising a second traveler contact; a flipper conductor comprising a flipper contact and coupled to the line conductor; an actuator operably coupled to the flipper conductor and structured to be manually actuated; and a housing portion comprising a support structure. The line conductor is structured to be connected to a power supply or electrical load. The second traveler conductor is structured to be connected to the load and to a reference terminal of the power source. The flipper conductor is structured to be actuated between a first position in which the flipper contact is physically contacting the first traveler contact and a second position in which the flipper contact is physically contacting the second traveler contact. The first traveler conductor comprises: a majority portion, and a bracing portion coupled to the majority portion. The bracing portion is interference fit onto the support structure. The first traveler conductor is produced from metal and the support structure is produced from thermoplastic.

### BRIEF DESCRIPTION OF THE DRAWINGS

A full understanding of the invention can be gained from the following description of the preferred embodiments when read in conjunction with the accompanying drawings in which:

FIG. 1A is a perspective view of the exterior of an electrical wiring device, which includes a front housing portion that is coupled to a prior art rear housing portion;

FIG. 1B is a perspective view of selected internal components included in the electrical wiring device shown in FIG. 1A, including a prior art traveler conductor, shown with the housing of the electrical wiring device removed;

FIG. 1C shows the interior of part of the prior art rear housing portion shown in FIG. 1A and provides an enlarged side view of the conductors and electrical contacts shown in FIG. 1B positioned within the prior art rear housing portion;

FIG. 2 shows a simplified depiction of two 3-way switches connected between a power source and a load;

FIG. 3A is an interior view of the prior art rear housing portion shown in FIG. 1A, showing some of the internal components from FIGS. 1B-1C and various structural supports formed in the interior of the prior art rear housing portion;

FIG. 3B is an enlarged side perspective view of some of the internal components and structural supports shown in FIGS. 1B-1C and 3A;

FIG. 4 shows a top elevation view of a traveler conductor and an adjacent structural support shown in FIGS. 3A-3B;

FIG. 5 shows an improved traveler conductor for use with an electrical wiring device, in accordance with an exemplary embodiment of the disclosed concept;

FIG. 6A is a perspective view of an improved rear housing portion for an electrical wiring device, with the improved traveler conductor of FIG. 5 shown installed and coupled to an improved structural support in the interior of the improved rear housing portion, in accordance with an exemplary embodiment of the disclosed concept;

FIG. 6B shows a portion of the view shown in FIG. 6A, enlarged in order to better show details of the improved structural support and its coupling to the improved traveler conductor;

FIG. 7A is a side sectional view of the interior of the improved rear housing portion shown in FIGS. 6A-6B, showing the coupling of the improved traveler conductor to the improved structural support, in accordance with an exemplary embodiment of the disclosed concept;

FIG. 7B is an enlargement of a portion of FIG. 7A; and

FIG. 8 is a perspective view of the exterior of an improved electrical wiring device, which includes a front housing portion that is coupled to the improved rear housing portion shown in FIGS. 6A-7.

### DETAILED DESCRIPTION OF THE INVENTION

Directional phrases used herein, such as, for example, left, right, front, back, top, bottom and derivatives thereof, relate to the orientation of the elements shown in the drawings and are not limiting upon the claims unless expressly recited therein.

As employed herein, the statement that two or more parts or components are “coupled” shall mean that the parts are joined or operate together either directly or indirectly, i.e., through one or more intermediate parts or components, so long as a link occurs. As used herein, “directly coupled” means that two elements are directly in contact with each other. As used herein, “fixedly coupled” or “fixed” means that two components are coupled so as to move as one while maintaining a constant orientation relative to each other.

As employed herein, when ordinal terms such as “first” and “second” are used to modify a noun, such use is simply intended to distinguish one item from another, and is not intended to require a sequential order unless specifically stated.

As employed herein, the term “number” shall mean one or an integer greater than one (i.e., a plurality).

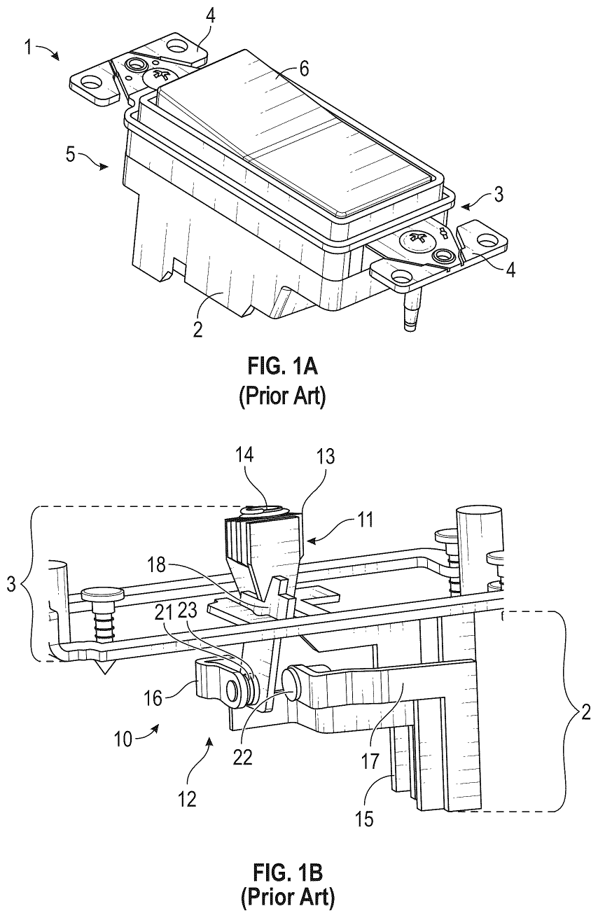

FIG. 1A is a perspective view of the exterior of an electrical wiring device 1 that is structured to be installed in a building. For example and without limitation, the electrical wiring device 1 can be mounted to the wall of a building. The wiring device 1 shown in FIG. 1A is specifically a rocker light switch, and while the improvements disclosed herein will be discussed with reference to the mechanism used for a rocker light switch, it will be apparent that the improvements disclosed herein can also be applied to other types of switches without departing from the scope of the disclosed concept. The electrical wiring device 1 comprises a rear housing portion 2, a front housing portion 3, and a number of mounting brackets 4. The rear housing portion 2 and the front housing portion 3 are structured to be coupled to one another in order to house various electrical and mechanical components of the electrical wiring device 1. When the rear housing portion 2 and the front housing portion 3 are coupled to one another, they can be collectively referred to as the device housing 5. The mounting brackets 4 enable the electrical wiring device 1 to be secured to a wall or other structure in a building.

The rear housing portion 2 is structured to enable various electrical components contained within the device housing 5 to be connected to conductors that are electrically connected to the utility or mains power provided to the building. The front housing portion 3 includes a paddle 6 structured to be actuated between different positions that correspond to different electrical states of the switching components contained within the device housing 5. Specifically, the paddle 6 can be actuated between a first position position and a second position, which respectively actuates a switch mechanism in the electrical wiring device 1 between a first state and a second state, which are detailed further hereafter.

Referring now to FIG. 1B, selected operational components 10 of the electrical wiring device 1 are shown. The electrical wiring device 1 shown in FIG. 1B is a 3-way switch, and the electrical wiring device 1 is thus sometimes referred to hereafter as the “3-way switch 1”, as context necessitates. The operational components 10 include both mechanical components 11 and electrical components 12. In FIG. 1B, the device housing 5 is removed in order to show the operational components 10 more clearly, but brackets with the reference numbers 2 and 3 are provided in order to denote where the rear housing portion 2 and the front housing portion 3 would be located if they were shown in the figure. It is noted that the electrical components 12 include a prior art traveler conductor 16, and that an improved electrical wiring device 101 detailed later herein in accordance with the disclosed concept includes an improved traveler conductor 116 instead of the prior art traveler conductor 16.

The mechanical components 11 include an actuator 13 and compression spring 14, with the actuator 13 and compression spring 14 being structured to be operatively coupled to and actuated by the paddle 6 shown in FIG. 1A. The electrical components 12 include a line conductor 15, a first traveler conductor 16, a second traveler conductor 17, and a flipper conductor 18. It is noted that the terms “first” and “second” are used simply to differentiate the two traveler conductors 16 and 17 from one another, and that the traveler conductor 17 can instead be referred to as “first” while the traveler conductor 16 is instead be referred to as “second” without departing from the scope of the disclosed concept. The first traveler conductor 16 comprises an electrical contact referred to hereinafter as the first traveler contact 21, the second traveler conductor 17 comprises an electrical contact referred to hereinafter as the second traveler contact 22, and the flipper conductor 18 comprises an electrical contact referred to hereafter as the flipper contact 23.

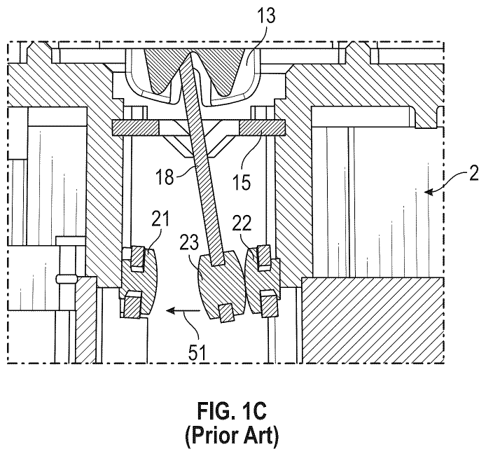

A 3-way switch such as the electrical wiring device 1 and the improved electrical wiring device 101 is typically wired in conjunction with another 3-way switch in order to switch a connected load (e.g. a light fixture) on and off. FIG. 2 is a simplified depiction showing how two 3-way switches are typically connected between a power source and a load/light fixture. The depiction shown in FIG. 2 applies to both the prior art electrical wiring device 1 and the improved electrical wiring device 101. The improved electrical wiring device 101 includes some of the same components included in the electrical wiring device 1 while including improved replacements for other components found in the 3-way switch 1. In FIG. 2, wherever two sets of reference numbers are shown for a single component, the first reference number denotes a component of the prior art electrical wiring device 1 and the second reference number refers to a component of the improved electrical wiring device 101. As shown in FIG. 2, 3-way switches are typically wired so that the load/light fixture will be electrically connected to the power source only when each 3-way switch is disposed in a state opposite to the state of the other 3-way switch. So, for a load/light fixture that is connected to two of the prior art 3-way switches 1 working in tandem, in order for the load/light fixture to receive power, the flipper conductor 18 of one of the 3-way switches 1 must be positioned as shown in FIG. 1B (i.e. with the flipper contact 23 in contact with the first traveler contact 21) and the flipper conductor 18 of the second 3-way switch 1 must be positioned as shown in FIG. 1C (i.e. with the flipper contact 23 in contact with the second traveler contact 22) 16. Conversely, when both of the 3-way switches 1 are disposed in the same state, the load/light fixture is electrically isolated from the power source, as should be ascertainable from FIG. 2.

As shown in FIG. 2, the line conductor 15 of each 3-way switch 1 is electrically connected either to a power source (e.g. utility/mains power supplied to the building) or a load (e.g. a light fixture). Each 3-way switch's flipper conductor 18 is coupled to the line conductor 15 such that the flipper conductor 18 is electrically connected to the line conductor 15 at all times. The flipper conductor 18 is structured to be actuated between a first position in which the flipper contact 23 is physically contacting the first traveler contact 21 (referred to hereafter as the “first position”, shown in FIG. 1B and schematically depicted in FIG. 2), and a second position in which it the flipper contact 23 is physically contacting the second traveler contact 22 (referred to hereafter as the “second position”, shown in FIG. 1C). The flipper conductor 18 is also coupled to the actuator 13. Because the paddle 6 (FIG. 1A), the actuator 13, and the flipper conductor 18 are all coupled to one another, actuating the paddle 6 causes corresponding actuation of the flipper conductor 18 between the first position and the second position.

The need for certain improvements to the first traveler conductor 16 that are detailed later herein arose from certain unintended effects that occur when the flipper conductor 18 is actuated from the second position (FIG. 1C) to the first position (FIG. 1B), as indicated by the arrow 51 in FIG. 1C. When the flipper conductor 18 is actuated from the second position to the first position in the direction 51 at high speeds, the fast motion of the flipper contact 23 results in micro-bouncing between the flipper contact 23 and the first traveler contact 21. This micro-bouncing causes arcing between the flipper contact 23 and the first traveler contact 21, which generates heat that burns the first traveler and flipper contacts 21, 23. Over time, this repeated burning causes the first traveler and flipper contacts 21, 23 to degrade to an undesirable degree.

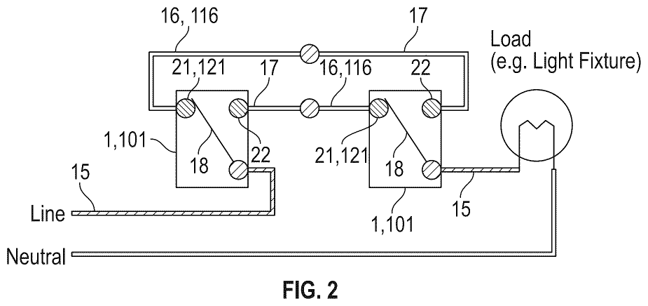

Reference is now made to FIGS. 3A-3B, which each show some of the operational components 10 shown in FIGS. 1B-IC positioned within the interior of the rear housing portion 2. In particular, in FIGS. 3A-3B, it can be seen that the interior of the rear housing portion 2 is formed with various support structures 30 that are used to stabilize the operational components 10 and/or secure the operational components 10 within the rear housing portion 2. As numbered in FIG. 3A, the portion of the first traveler conductor 16 that includes the first traveler contact 21 can be referred to as the first traveler contact arm 25.

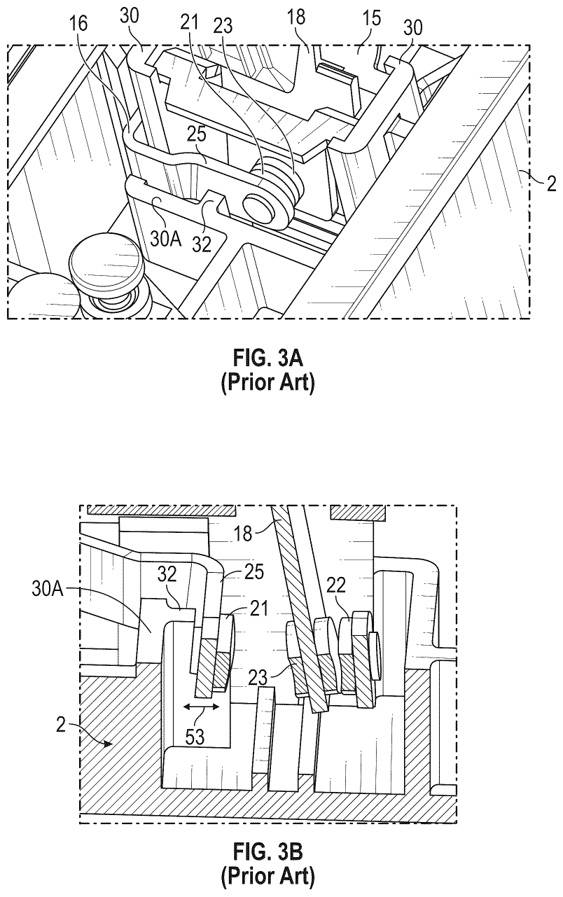

One of the support structures 30, numbered as 30A, comprises a rib 32 and is in close proximity to the first traveler contact arm 25. As shown in FIGS. 3A-4, the rear housing 2 and first traveler conductor 16 are structured such that, when the first traveler conductor 16 is installed in the rear housing 2, there is a gap between the first traveler contact arm 25 and the rib 32. As such, when the flipper conductor 18 is actuated from the OFF state to the ON state, when the flipper contact 23 hits the first traveler contact 21 with sufficient force, the first traveler contact arm 25 vibrates in the dimension 53 (the dimension 53 being indicated by the double arrow 53 in FIGS. 3B and 4).

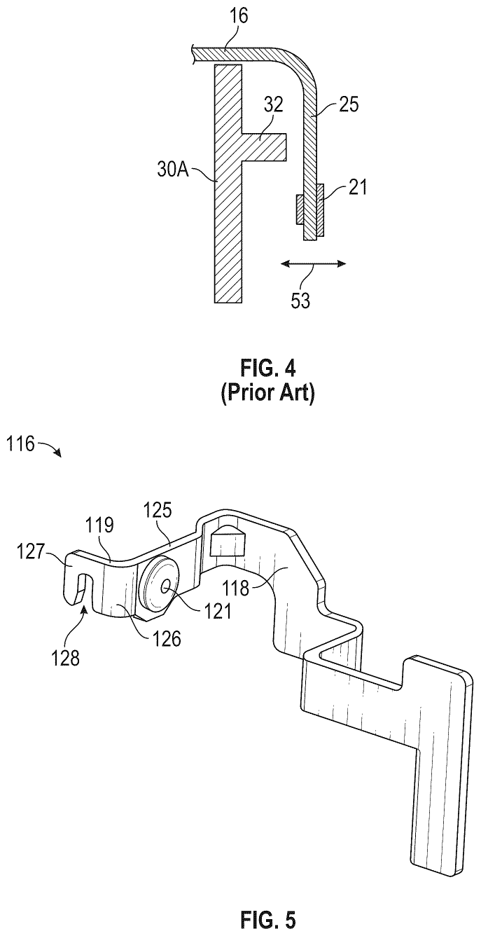

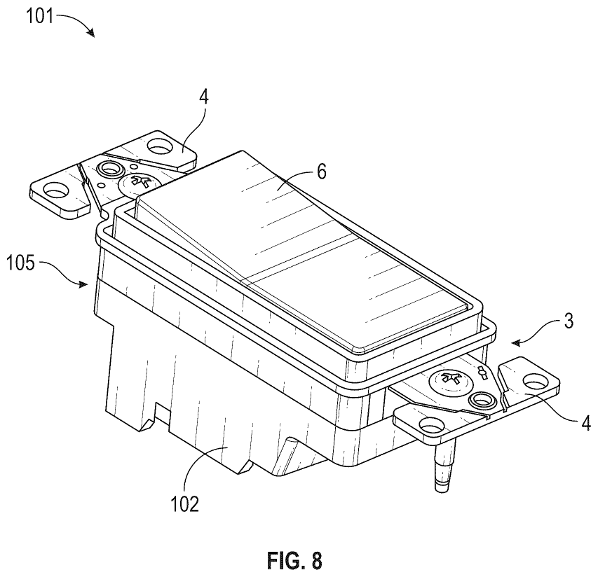

Reference is now made to FIGS. 5-7B, which show an improved rear housing 102 and an improved first traveler conductor 116 for an electrical wiring device 101 (FIG. 8), in accordance with exemplary embodiments of the disclosed concept. It is noted that the exterior of the electrical wiring device 101 as shown in FIG. 8 is identical to the prior art wiring device 1 shown in FIG. 1, but the device housing 105 includes features with its interior, specifically within the rear housing portion 102, that are improved relative to corresponding features of the prior art device housing 5 and prior art rear housing portion 2. The rear housing portion 102 is structurally similar to the prior art rear housing portion 2, except that the rear housing portion 102 is formed with a support structure 130A that provides an improvement over the support structure 30A of the prior art rear housing portion 2, as detailed further hereinafter. The first traveler conductor 116 is similar in structure to the prior art first traveler conductor 16, except that the first traveler conductor 116 includes an additional bracing component that provides an improvement over the prior art first traveler conductor 16, as detailed further hereinafter. Similarly to the prior art traveler conductor 16, the improved traveler conductor 116 can instead be referred to as “first” while the traveler conductor 17 is instead referred to as “second”, without departing from the scope of the disclosed concept.

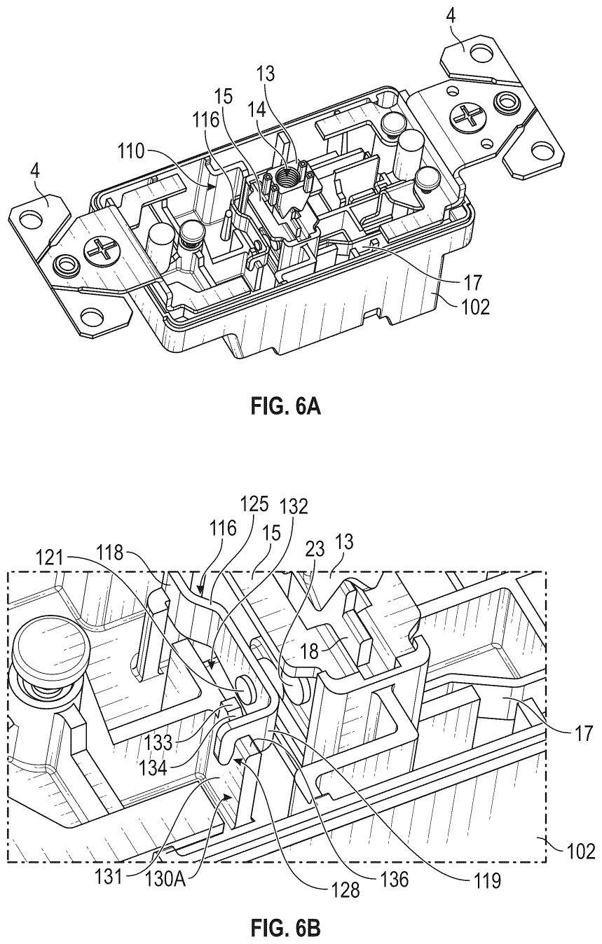

The rear housing portion 102 is structured to be coupled to the front housing portion 3 shown in FIG. 1A in order to form an improved electrical wiring device 101, as shown in FIG. 8. Aside from the prior art first traveler conductor 16 being replaced with the improved first traveler conductor 116 in the improved electrical wiring device 101, the remaining operational components 10 that are included in the prior art electrical wiring device 1 are also included in the improved electrical wiring device 101. That is, the improved electrical wiring device 101 includes the same mechanical components 11 that are used in the electrical wiring device 1 (i.e. the actuator 13 and compression spring 14), and also includes the line conductor 15, the second traveler conductor 17, and the flipper conductor 18 that are used in the electrical wiring device 1. Thus, the group of operational components included in the improved electrical wiring device 101 can be referred to using the reference number 110 (as used in FIG. 6A), and should be understood to include the actuator 13, the compression spring 14, the line conductor 15, the second traveler conductor 17, the improved first traveler conductor 116, and the flipper conductor 18 (numbered in FIG. 6B but not in FIG. 6A).

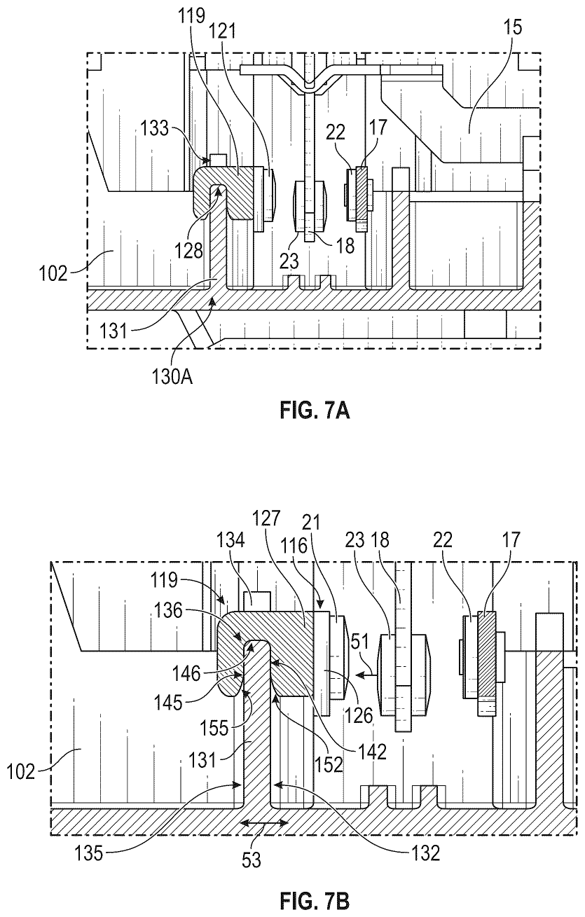

Referring now to FIG. 5, as previously noted, the first traveler conductor 116 is similar in structure to the prior art first traveler conductor 16, but additionally includes an advantageous bracing component that the prior art first traveler conductor 16 does not include. Specifically, the first traveler conductor 116 comprises both a majority portion 118 and a bracing portion 119 that are coupled to one another. The majority portion 118 is nearly identical in structure to the prior art first traveler conductor 16, while the bracing portion 119 is an advantageous structure not found in the prior art first traveler conductor 16. The majority portion 118 includes a first traveler contact 121. The majority portion 118, the first traveler contact 121, and the bracing portion 119 are all produced from metal, so as to be electrically conductive. As will become apparent from the discussion of FIGS. 6A-7B provided hereinafter, the structural features of the bracing portion 119 enable the first traveler conductor 116 to be advantageously coupled to an improved structural support formed in the improved rear housing portion 102. The bracing portion 119 is useful because the first traveler conductor 116 is intended to be stationary and because keeping the first traveler contact 121 as still as possible after being impacted by the moving contact 23 is desired.

As numbered in FIG. 5, the portion of the first traveler conductor 116 that includes the first traveler contact 121 is the first traveler contact arm 125. The first traveler contact arm 125 is substantially planar. The bracing portion 119 comprises a bent portion 126 and a planar portion 127, with the bent portion 126 being coupled to the first traveler contact arm 125 and the planar portion 127 extending from the bent portion 126 away from the first traveler contact arm 125. The bent portion 126 is angled so that the planar portion 127 is disposed perpendicularly to the first traveler contact arm 125. The planar portion 127 comprises an inlet 128. As can be seen in FIG. 6B, the inlet 128 is structured so as to enable the first traveler conductor's bracing portion 119 to be interference fit (i.e. press fit) onto a support structure 130A of the rear housing portion 102. That is, the inlet 128 and a main body 131 of the support structure 130A are structured so that the main body 131 can be received within the inlet 128.

It is noted that the support structure 130A is made of thermoplastic, the significance of which is detailed further later herein. As shown in FIG. 6B, the bracing portion 119 and the support structure 130A are structured such that, when the bracing portion 119 is interference fit onto the support structure 130A, the first traveler contact arm 125 of the first traveler conductor 116 is parallel with an arm-facing surface 132 of the support structure 130A.

Referring to FIG. 6B, in addition to the support structure's main body 131 being structured to be received within the inlet 128 of the first traveler conductor's bracing portion 119, the support structure 130A also comprises a guide portion 133 that makes it easier to interference fit the first traveler conductor's bracing portion 119 onto the main body 131 during the automated assembly process. The guide portion 133 is a protrusion that extends away from the main body 131 and comprises a sloped surface 134 (relative to the view shown in the figures, the guide portion 133 extends upward away from the main body 131). The sloped surface 134 is structured to be engaged by the inlet 128 of the bracing portion 119 as the first traveler conductor 116 approaches the support structure 130A during assembly. Relative to the view shown in the figures, the bracing portion 119 moves downward toward the support structure 130A during the assembly process, and once the bracing portion's inlet 128 engages the guide portion's sloped surface 134, the continued application of downward force on the bracing portion 119 causes the bracing portion 119 to slide down the sloped surface 134 until the inlet 128 disengages from the guide portion 133 and receives the top of the main body 131 of the support structure 130A.

Referring now to FIGS. 7A-7B, the arm-facing surface 132 of the support structure 130A is planar, and the support structure 130A comprises a second planar surface 135 that faces a direction opposite that which the arm-facing surface 132 faces. The support structure 130A further comprises a connecting surface 136 that extends between the arm-facing surface 132 and the planar surface 135. The inlet 128 of the first traveler conductor's bracing portion 119 correspondingly comprises a first planar inlet surface 142, a second planar inlet surface 145, and a connecting inlet surface 146 that extends between the first planar inlet surface 142 and the second planar inlet surface 145. The first planar inlet surface 142 and second planar inlet surface 145 face one another. The first planar inlet surface 142, the second planar inlet surface 145, and the connecting inlet surface 146 are structured to respectively engage the support structure's arm-facing surface 132, planar surface 135, and connecting surface 136 in order to facilitate the interference fit between the first traveler conductor's bracing portion 119 and the support structure's main body 131.

Referring briefly again to the guide portion 133 of the support structure 130A, as shown in FIG. 6B, the guide portion 133 extends away from the connecting surface 136 of the main body 131 in particular, such that the guide portion 133 comprises a first end connected to the connecting surface 136 and a second end disposed opposite the first end. The sloped surface 134 slopes from the second end toward the connecting surface 136.

Continuing to refer to FIGS. 7A-7B, the inlet 128 of the first traveler conductor's bracing portion 119 further comprises a first angled surface 152 and a second angled surface 155 (numbered in FIG. 7B). The first planar inlet surface 142 extends between the connecting inlet surface 146 and the first angled surface 152. The second planar inlet surface 145 extends between the connecting inlet surface 146 and the second angled surface 155. The first angled surface 152 faces the support structure's arm-facing surface 132 and is spaced apart from the arm-facing surface 132 when no external force is acting upon the first traveler conductor 116. The second angled surface 155 faces the support structure's planar surface 135 and is spaced apart from the planar surface 135 when no external force is acting upon the first traveler conductor 116. The first angled surface 152 and the second angled surface 155 are angled such that the inlet 128 is wider between the first and second angled surfaces 152, 155 than it is between the first and second planar inlet surfaces 142, 145.

The structural features of the first traveler conductor's bracing portion 119 enable the bracing portion 119 to function in conjunction with the support structure 130A and take advantage of the material properties of the support structure 130A in order to significantly reduce the number of micro-bounces (i.e. vibrations) of the first traveler conductor 116 that would otherwise occur if the bracing portion 119 were not included in the first traveler conductor 116. The thermoplastic from which the support structure 130A is produced has a lower resonant frequency than the metal from which the first traveler conductor 116 is produced. As a result, in the improved electrical wiring device 101, when the flipper conductor 18 is actuated in the direction 51 (FIG. 7B) and the flipper contact 23 impacts the first traveler contact 121, the thermoplastic of the main body 131 dampens the vibrations of the first traveler contact 121. In addition, when the moving contact 23 impacts the first traveler contact 121, the bracing portion's first angled surface 152 and second angled surface 155 enable the bracing structure 119 to be displaced in the dimension 53 (FIG. 7B) in a manner that significantly reduces the displacement that the first traveler contact arm 125 would otherwise experience in the dimension 53. That is, when the moving contact 23 impacts the first traveler contact 121, the bracing structure 119 tilts slightly back and forth relative to the dimension 53 such that the first angled surface 152 and the second angled surface 155 alternately respectively engage with the arm-facing surface 132 and planar surface 135 of the support structure 130A. This two-way bracing performed by the bracing structure 119 in the dimension 53 results in the first traveler contact 121 experiencing significantly less displacement in the dimension 53.

During product testing, several trials were conducted in which the same amount of force was used to actuate the flipper conductor 18 in the direction 51 (numbered in FIGS. 1C and 7B) in both the prior art electrical wiring device 1 and in the disclosed improved electrical wiring device 101, so that the number of bounces and duration of bouncing of the first traveler contacts 21 and 121 could be compared. In the prior art electrical wiring device 1, the first traveler contact 21 bounced an average of 17 times, with the total bounce time averaging 1.45 milliseconds (ms). In the disclosed improved electrical wiring device 101, the first traveler contact 121 bounced an average of only 3 to 4 times, with the total bounce time averaging only 364 microseconds (us).

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of disclosed concept which is to be given the full breadth of the claims appended and any and all equivalents thereof.

What is claimed is:

1. A bracing portion for stabilizing a traveler conductor in an electrical wiring device, the bracing portion comprising:
a bent portion structured to be coupled to the traveler conductor; and
a planar portion, the planar portion being adjacent to the bent portion and comprising an inlet, the inlet comprising:
a first planar inlet surface;
a second planar inlet surface; and
a connecting inlet surface that extends between the first planar inlet surface and the second planar inlet surface,
wherein the first planar inlet surface and the second planar inlet surface face one another, and
wherein the inlet is structured to receive a support structure of the electrical wiring device.

2. The bracing portion of claim 1, wherein the inlet further comprises:
a first angled surface; and
a second angled surface,
wherein the first planar inlet surface extends between the connecting inlet surface and the first angled surface,
wherein the second planar inlet surface extends between the connecting inlet surface and the second angled surface, and
wherein the first angled surface and the second angled surface are angled such that the inlet is wider between the first and second angled surfaces than it is between the first and second planar inlet surfaces.

3. The bracing portion of claim 1,
wherein the bent portion is structured in order to position the planar portion perpendicularly to an arm of the traveler conductor comprising a traveler contact.

4. A traveler conductor for an electrical wiring device, the traveler conductor comprising:
a majority portion; and
a bracing portion structured to stabilize the traveler conductor, the bracing portion comprising:
a bent portion structured to be coupled to the majority portion; and
a planar portion, the planar portion being adjacent to the bent portion and comprising an inlet, the inlet comprising:
a first planar inlet surface;
a second planar inlet surface; and
a connecting inlet surface that extends between the first planar inlet surface and the second planar inlet surface,
wherein the first planar inlet surface and the second planar inlet surface face one another, and
wherein the inlet is structured to receive a support structure of the electrical wiring device.

5. The traveler conductor of claim 4, wherein the inlet further comprises:
a first angled surface; and
a second angled surface,
wherein the first planar inlet surface extends between the connecting inlet surface and the first angled surface,
wherein the second planar inlet surface extends between the connecting inlet surface and the second angled surface, and
wherein the first angled surface and the second angled surface are angled such that the inlet is wider between the first and second angled surfaces than it is between the first and second planar inlet surfaces.

6. The traveler conductor of claim 4, further comprising:
a planar arm comprising a traveler contact,
wherein the bent portion is structured in order to position the planar portion perpendicularly to the arm.

7. An electrical wiring device structured to switch power between a power source and a load, the electrical wiring device comprising:
a first traveler conductor comprising a first traveler contact;
a line conductor;
a second traveler conductor comprising a second traveler contact;
a flipper conductor comprising a flipper contact and coupled to the line conductor;
an actuator operably coupled to the flipper conductor and structured to be manually actuated; and
a housing portion comprising a support structure,
wherein the line conductor is structured to be connected to a power supply or electrical load,
wherein the flipper conductor is structured to be actuated between a first position in which the flipper contact is physically contacting the first traveler contact and a second position in which the flipper contact is physically contacting the second traveler contact,
wherein the first traveler conductor comprises:
a majority portion; and
a bracing portion coupled to the majority portion,
wherein the bracing portion is interference fit onto the support structure, and
wherein the first traveler conductor is produced from metal and the support structure is produced from thermoplastic.

8. The electrical wiring device of claim 7,
wherein the bracing portion of the first traveler conductor comprises:
a bent portion structured to be coupled to the majority portion; and
a planar portion, the planar portion being adjacent to the bent portion and comprising an inlet, the inlet comprising:
a first planar inlet surface;
a second planar inlet surface; and
a connecting inlet surface that extends between the first planar inlet surface and the second planar inlet surface,
wherein the first planar inlet surface and the second planar inlet surface face one another,
wherein the inlet is structured to receive a main body of the support structure.

9. The electrical wiring device of claim 8,
wherein the inlet of the bracing portion further comprises:
a first angled surface; and
a second angled surface,
wherein the first planar inlet surface extends between the connecting inlet surface and the first angled surface,
wherein the second planar inlet surface extends between the connecting inlet surface and the second angled surface, and
wherein the first angled surface and the second angled surface are angled such that the inlet is wider between the first and second angled surfaces than it is between the first and second planar inlet first angled surface surfaces.

10. The electrical wiring device of claim 9,
wherein the first planar inlet surface, the second planar inlet surface, and the connecting inlet surface all engage the main body of the support structure, and
wherein there is a gap between the first angled surface and the main body, and
wherein there is a gap between the second angled surface and the main body.

11. The electrical wiring device of claim 7,
wherein the first traveler conductor further comprises a contact arm comprising the first traveler contact, and
wherein the planar portion of the bracing portion is positioned perpendicularly to the contact arm.
